(19) United States
(12) Patent Application Publication
(10) Pub. No.: US 2006/0094413 A1
(43) Pub. Date: May 4, 2006

(54) Application protocol identification

(76) Inventors: Mark S. Evans, Plano, TX (US); Alan L. Gerhardt, Pittsburg, TX (US); Warner Lee Hines, Southlake, TX (US); Raymond M. Parker, Carrollton, TX (US); Robert L. Reeves, Plano, TX (US); Paul D. Schepers, Frisco, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/978,665

(22) Filed: Nov. 1, 2004

(51) Int. Cl. H04M 3/00

(52) U.S. Cl. 455/418

(57) ABSTRACT

Networks, methods, and devices are provided for handling a session in a telecommunications network. One method embodiment includes receiving a service request to a network device. The service request is associated with a service application. The method includes identifying a protocol type to handle the session based on a database look up. The method includes instantiating a program on the network device appropriate to the protocol type based on identifying the protocol type.

Intelligent networks (INs) are being used to provide an increasing number of services to communication networks. INs deliver these services to a number of wireline and wireless stations, e.g., communications devices such as phones, PDA's, etc. The service functions that deliver the services to these stations can be separated from the equipment that is providing the switching functionality to the stations. One benefit of this separation is that network providers do not have to perform major modifications on multiple physical switches when a new service is introduced. For example, in a publicly switched telephone network (PSTN) a physical circuit based switch connects a call signal, or other media data traffic, on one media channel to another available media channel in order to continue routing the signal to the intended destination. INs can provide enhanced voice, video, and data services and dynamic routing capabilities by using a number of different program switches. In both INs and the PSTN, the actual voice call can be transmitted over a circuit-switched network, but the signaling, e.g., control signal transmission, can be accomplished by executing program instructions on a separate SS7 packet-switched network.

The transaction capabilities application part (TCAP) is a layer in the SS7 protocol stack that is used to communicate between various IN elements, e.g., switching points/centers, control points, end points, etc. The TCAP works to transfer (e.g., send and receive) messages from a variety of different protocols. For example, the TCAP is used to send database queries to a service control point (SCP). It is also used to send non-circuit related messages between switches, e.g., service switching points (SSPs). TCAP keeps track of multiple queries that are part of the same session, e.g., message exchange, associated with a call or service request within a communication network or between networks.

IN application part (INAP) protocols are found in another layer of the SS7 architecture. INAP protocols are used to define the operations required between IN network elements, e.g., SSPs and SCPs, to initiate non-circuit related functions (e.g., not dealing with connect/disconnect) throughout a network, etc. INAP protocols use TCAP to access remote devices. Mobil application part (MAP) protocols are also considered within this layer of the SS7 and enable mobile (e.g., cellular) carriers to use the SS7 network. MAP protocols also allow a mobile device's (e.g., cellphone/PDA/multifunction device) telephone number and serial number to be transmitted over the network. Additional protocol examples which can be included in the final layer include, but are not limited to, customized applications for mobile network enhanced logic (CAMEL), and capability set (CS) protocols, to name a few.

The occurrence of network-enabled applications, such as a web-based Parlay applications (described below), are becoming more frequent in INs. Next generation service application programs are being written according to a number of different protocols. The protocol of a given service application program, however, may not be identified in advance when a service request is made using TCAP. This is because, with TCAP, the messages are routed to and from a service application program using point code to provide the routing directions.

Point code is a SS7 address of a network component, used to identify the signaling point, e.g., a called number, in SS7 messages. Point code typically includes location information such as a network identifier. However, this information does not identify the protocol of the service application that is being requested, e.g., called, or the service application that is initiating a session.

Service logic programs (SLPs) are used in telecommunication networks to handle sessions, e.g., message exchanges, between various requested services on a network. For example, SLPs can operate in a service logic execution environment (SLEE) to provide a service control function (SCF) within an SCP. As the number of protocols used in networks has grown many SLPs for telecommunications are now written by programmers to accommodate numerous protocol types. This is done in order to provide a SLP which is suitable to handle a message exchange in the appropriate protocol since the appropriate protocol type may not be known in advance. Unfortunately, such SLPs are larger in size than their protocol specific SLPs counterparts and accordingly consume greater processor and memory resources.

### BRIEF DESCRIPTION OF THE DRAWINGS

FIG. 1 is a block diagram illustrating an example communication network with which program embodiments described herein can be implemented.

FIG. 2 illustrates an embodiment for a plug in container having a dispatcher program connected to a protocol database and to a multiple service logic execution environment (multi-SLEE).

FIG. 3A is a block diagram illustrating an example operational embodiment for accessing and retrieving protocol information from a protocol database embodiment using a dispatcher program.

FIG. 3B illustrates a table embodiment with called numbers associated to particular protocol types.

FIG. 4 is an example illustration of the interaction between a number of network functions and service applications via a SCP having a plug in container according to embodiments described herein.

### DETAILED DESCRIPTION

Embodiments of the present invention cover networks, methods, and devices for handling a session in a telecommunications network. For example, a network device is provided including a processor coupled to a memory. Program instructions are provided, storable in the memory and executable by the processor, to receive a service request to the network device as initiated by a service application accessible to the network. The program instructions execute to search a protocol database and identify a protocol type of the service application. The program instructions execute to instantiate a service logic program (SLP) on the network device appropriate to the protocol type in order to handle a session with the service application.

Method embodiments are provided for instantiating a protocol-specific SLP. One method embodiment includes receiving a service request to a network device, the service request being initiated by a service application accessible to the network. The method includes executing instructions associated with a dispatcher program to search a protocol database in order to identify a protocol type of the service application. The method further includes instantiating a protocol specific service logic program (SLP) on the network device based on identifying the protocol type.

Example Communications Network

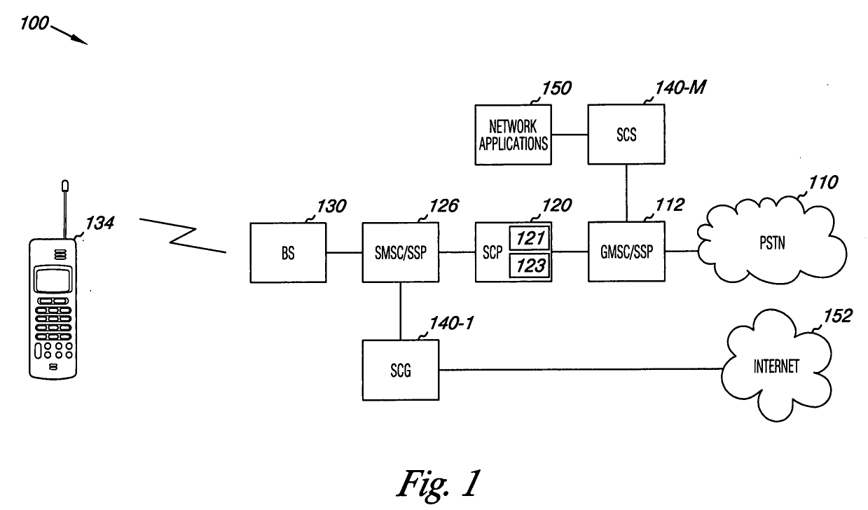

FIG. 1 illustrates one example of some of the physical components (also referred to as physical entities (PEs)) in a telecommunications network. In this example, a telecommunications network 100 is illustrated. Wireless telecommunications networks such as shown in FIG. 1 can be operated by an industry wireless provider or operator, e.g., Cingular, Vodafone, Verizon, Nextel, Sprint, and T-Mobile. Such wireless networks can provide cellular/PCS (personal communication service) services like call origination and call delivery, streaming data, text messaging, etc., to a mobile device or handset 134.

Wireless networks 100 include one or more mobile switching centers (MSCs). For example, FIG. 1 illustrates a gateway MSC/service switching point (GMSC/SSP) 112 and a serving MSC/service switching point (SMSC/SSP) 126 (described in more detail below) which are connected to a base station (BS) 130. Base stations 130 are dispersed throughout the geographic area serviced by the network 100. Each MSC, e.g., 112 and 126, is responsible for establishing and maintaining calls between mobile devices and/or between a mobile device and a wireline device which is connected to the wireless network 100 from a local and/or long-distance, wireline/circuit-switched based network, e.g., the PSTN 110. Embodiments of the present invention can be utilized in wireless, wireline, or combination wireline-wireless networks.

A MSC 112/126 is a telephone switch specialized for wireless and mobility support. A MSC 112/126 performs various functions, including mobility management, call handoffs, call admission, call control, resource allocation, and so forth. A call and/or other data can be relayed from the MSC 112/126 to base stations 130. This relay can be via a wireless communication interface to the mobile device 134 according to various interface protocol standards, e.g., an american national standards institute (ANSI), a global systems for mobile (GSM), or other standards interface, etc.

In the embodiment of FIG. 1, MSCs 112 and 126 are designated as a gateway MSC 112 (GMSC) and a serving MSC (SMSC) 126. This designation is provided to illustrate that a MSC can provide various functions. For example, a GMSC is used to receive an initial communication from a mobile device or from outside the given network (e.g., the PSTN 110 to the wireless network 100). A SMSC is used to provide the actual routing to a mobile device to which the communication is directed, i.e., the called number. In some cases, the GMSC and the SMSC can be provided by the same MSC.

As illustrated in the example network of FIG. 1, an MSC, e.g., 112 and 126, can also serve as SSPs. A SSP directs requests for communication and/or application services (hereinafter “service request”) through the network 100. For example, a service request can be sent from a mobile device 134, or a service application located elsewhere on the network (discussed in more detail below), and the SSP's function embodied within the GMSC 112 and SMSC 126 will execute program instructions to receive, process and appropriately route the service request, e.g., to another wireless/wireline and/or service application. When a service request is received the SSP opens a dialogue with another media platform, e.g., a service control gateway (SCG) or service capability server (SCS), and exchanges protocol messages embedded within SS7 protocol messages with the SCG or SCS.

As shown in FIG. 1, a SCP 120 is used to handle the message exchange, e.g., session, between devices and/or applications. That is, the SCP 120 can receive a service request from a mobile device 134 or wireline device (e.g., through the PSTN 110) via the GMSC 112 or SMSC 126 and instantiate a program, e.g., an SLP, to handle the message exchange with a service control gateway (SCG) 140-1 (shown connected to the Internet 150) and/or service capability server (SCS) 140-M (shown connected to other network applications 150), etc. The designator “M” is used to indicate that a given SCP 120 may handle message exchanges, or sessions, with a number of different network entities. A SCG 140-1 and/or SCS 140-M can provide access to other network functionality such as network service applications (e.g., web-based Parlay applications), home location registers (HLRs), visiting location register (VLRs), etc., as the same will be known and understood by one of ordinary skill in the art. For example, one of ordinary skill in the art will appreciate the interaction between an application incorporating a Parlay web service and a server implementing the web service, e.g., a service capability server (SCS) or service control gateway (SCG). That is, a Parlay application, or other network application, can generate a call, e.g. has the capability to initiate a call session to a particular called number. More detail is not provided here so as not to obscure embodiments of the present application. Parlay web services are one of a development tool which can accommodate the development of next generation telecommunication network applications. Parlay services are not network equipment specific, and are not network specific where a particular capability is relevant to more than one type of network. Embodiments, as described below, include program instructions which can instantiate a protocol specific SLP to handle calls initiated by a Parlay application on a telecommunications network.

Each of the physical components of the network 100 can include access to processor and memory resources, as the same are known and understood in the art. By way of example, and not by way of limitation, the network example of FIG. 1 illustrates the SCP 120 having access to such processor and memory resources. Embodiments, however, are not limited to the network illustration provided in FIG. 1.

Example Embodiment of a Plug in Container having Dispatcher Program for Protocol Lookup

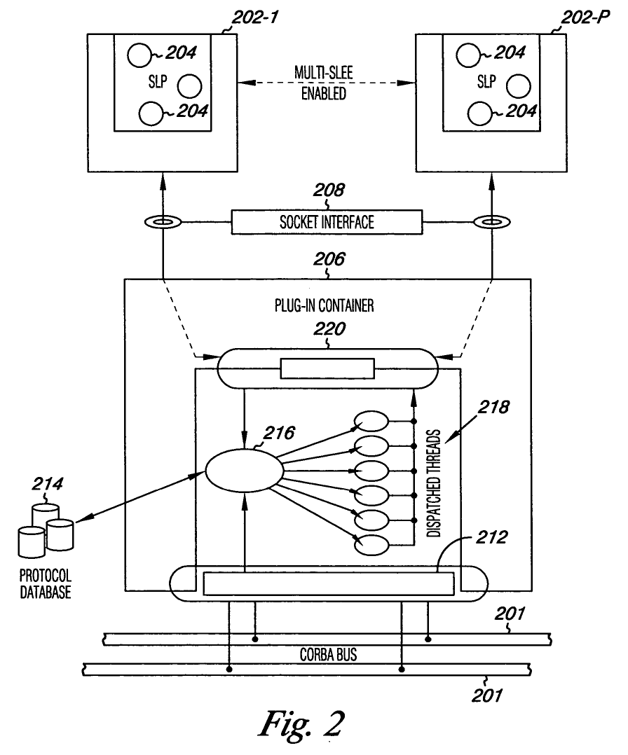

FIG. 2 illustrates a plug-in container 206 connecting a network signal path 201 to one or more service logic execution environments (SLEEs), illustrated as 202-1, . . . , 202-P. For example, the network signal path 201 can include a high speed bus, e.g., a common object request broker architecture (CORBA) bus, as the same is known and understood by one of ordinary skill in the art. The network signal path 201 can provide a connection between user space network applications, e.g., network-enabled applications such as a web-based Parlay application, and the SLEEs, 202-1, . . . , 202-P via the plug in container 206.

The plug-in container 206 and SLEE can be provided as part of a service control function (SCF) in a SCP and/or as part of a service control gateway (SCG) or service capability server (SCS) as shown in FIG. 1. Embodiments, however, are not limited to these examples. The designator “P” is intended to indicate that embodiments are not limited to a particular number of SLEEs and can include a multi-SLEE environment. As the reader will appreciate, the given number of SLEEs in a given SLEE environment is associated with the amount of processing resources available, e.g., number of processors (CPUs), in a given computing device. Each SLEE is generally assigned to a particular processor, however, multiple SLEEs can be assigned to one processor and the associated memory allocated to that particular processor.

As shown in FIG. 2, instances of one or more SLPs 204 can be created and executed within a SLEE (e.g., in response to a service request received to an SCP, SCS, SCG, etc., from a SSP as shown in FIG. 1) in order to handle message exchanges between various network applications and devices. That is, each SLEE can have multiple instances of SLPs 204 at a particular point in time. As noted above, the message exchanges will use an SLP which is appropriate to a particular protocol. This protocol will vary depending on the type of network application or device initiating the service request. As illustrated in the example the multiple SLEEs, 202-1, . . . , 202-P, can connect to the plug-in container 206 via a socket interface 208 as the same are known and understood by one of ordinary skill in the art. Also, as shown in FIG. 2, as service requests and messages are exchanged between the plug-in container 206 and the network signal path, or bus, 201 they are handled by an external component interface 212 (as the same are known and understood) provided to the plug-in container 206.

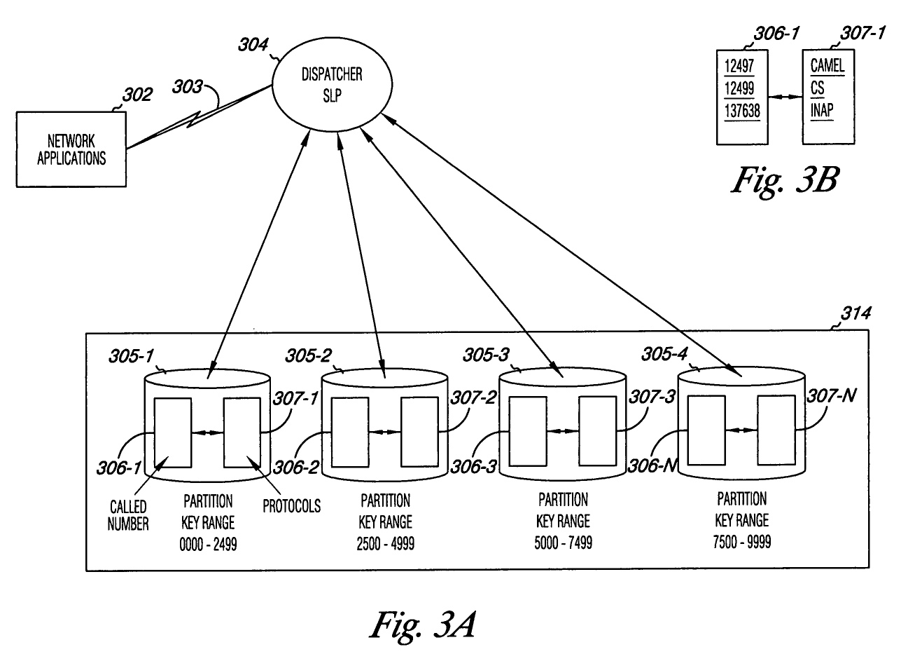

According to embodiments of the present invention, a dispatcher program 216 is provided to the plug-in container 206. The dispatcher program 216 includes instructions which can execute to retrieve protocol information from a protocol database 214 (discussed further with FIG. 3A). As noted above, TCAP is the layer within the SS7 protocol that is used to communicate between IN elements, e.g., switching points/centers, control points, end points, etc. That is, TCAP protocol is used to communicate messages between different entities such as databases and end stations. For example, TCAP messages are typically used for communication between SSPs and SCPs within a communication network or between networks. As the reader will appreciate, the TCAP and/or other layer in the SS7 architecture will contain “called number” information and/or “session type”. One of ordinary skill in the art will appreciate the manner in which program instructions can execute to identify and extract a called number (or portion thereof) and/or a session, e.g., ANSI and/or GSM, type from a TCAP and/or other SS7 layer message, e.g., a called number may be extracted from a MAP message. More detail is not provided here so as not to obscure embodiments of the present invention. Such messages, however, may not identify the protocol type of a network application initiated call session.

According to various embodiments, the dispatcher program instructions execute to use called number and session type information to look up and retrieve protocol information from the protocol database 214. For example, as described more in connection with FIG. 3A, called numbers can be associated with various protocol types in the database in order to identify a protocol type by its association with a particular called number. Once a protocol type is identified according to such a technique, the program instructions can execute to use this information to launch a protocol appropriate program to handle the particular protocol type. For example, once a protocol type is retrieved the dispatcher program 216 executes instructions to instantiate a protocol specific SLP 204 to handle a message exchange associated with a service request. Protocol specific SLPs can be more compact in size and thus consume less processor and memory resources than SLPs written to accommodate multiple protocols. Further, more compact, protocol specific SLPs can allow identical hardware to accommodate more SLPs instances at one time. And, as the reader will appreciate, more executing SLPs means a given SLEE can handle more communication sessions. One of ordinary skill in the art will appreciate the manner in which an SLP can be written by a program developer to be protocol specific. More detail is not provided here so as not to obscure embodiments of the dispatcher program itself and its use with the protocol database.

FIG. 2 illustrates the dispatcher program 216 executing instructions to dispatch a number of threads 218 which will be used by the SLEE to instantiate protocol specific SLPs 204 in the SLEEs, 202-1, . . . , 202-P. A thread is an executable set of instructions being executed on a processor. An SLP “instance” can also be referred to as a user level thread for a user level program, e.g., SLP as opposed to a kernel or operating system program. Use of the language “to instantiate”, or “instantiating”, an SLP is intended to mean creating or launching a particular program instance as the same will be known and understood by one of ordinary skill in the art.

In FIG. 2, the dispatched threads 218 are exchanged with the SLEEs, 202-1, . . . , 202-P, through an application program interface (API) 220 and via the socket interface 208 (as the same are both appreciated by one of ordinary skill in the art), to instantiate various SLPs 204. Thus, as one example, program instructions described herein can execute to launch a Parlay protocol specific SLP, based on using the called number in the above database look up, in order to handle a session with a Parlay initiated call. The protocol specific SLPs 204 in the SLEEs, 202-1, . . . , 202-P provide the connection information, and session handling (e.g., exchange messages for calls and services) as part of the SCF to access the application logic for user applications wherever they may be located in the network (e.g., network applications 150 in FIG. 1). The protocol specific SLPs 204 can include SLPs written to function with MAP (whether ANSI or GSM session types), INAP, CAMEL2, CAMEL3, and CS protocols, etc., to name a few.

Operational Embodiment for Accessing and Retrieving Protocol Information from a Protocol Database Embodiment Using a Dispatcher Program

FIG. 3A illustrates an embodiment of a database 314 interfaced to one or more network applications, shown as 302 via a dispatcher program 304 (such as dispatcher program 216 shown in FIG. 2). The embodiment of FIG. 3A can be part of a wireless communications network 302, such as an ANSI-41 and/or GSM MAP type of network, as the same has been described herein. By way of illustration and not by way of limitation, database 314 is illustrated as a group of one or more physical databases, 305-1, 305-2, 305-3, and 305-4. More or fewer physical databases can be grouped together. As one of ordinary skill in the art will appreciate this database group (hereinafter “database 314”) can include one or more sets of computer executable instructions, software, and/or application modules for managing and partitioning data within database 314.

By way of example and not by way of limitation, the one or more physical databases, 305-1, 305-2, 305-3, and 305-4 in database 314 are shown partitioned into four key ranges. (“key” being defined further below). That is, physical database 305-1 includes a partition key range of four digits within the grouping of 0000-2499. Physical database 305-2 includes a partition key range of 2500-4999. Physical database 305-3 includes a partition key range of 5000-7499. And, physical database 305-4 includes a partition key range of 7500-9999, etc. The invention however, is not limited to partitioning a database into four key ranges. Fewer or more key range partitions are considered within the scope of the present invention.

Further, as one of ordinary skill in the art will appreciate the group of one or more physical databases, 305-1, 305-2, 305-3, and 305-4 within database 314 can be grouped according to other techniques other than by key ranges, e.g., by a session type. As the reader will appreciate session types can include ANSI and/or GSM message session types. Embodiments, however, are not limited to these examples.

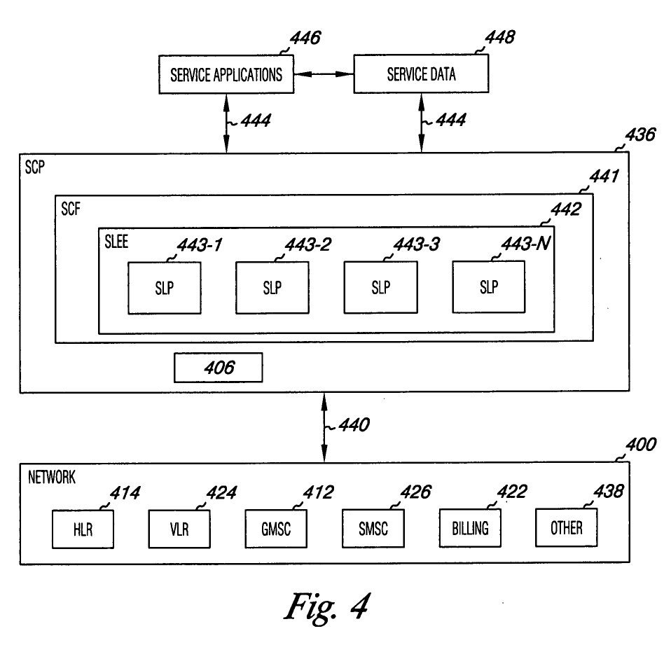

In wireless networks various numbering conventions are used for subscriber phone numbers according to the protocol type of the particular wireless network. For example, in a GSM network a digit length of 6-18 digits is used for the subscriber's number and is referred to as an international mobile subscriber identity (IMSI) number with a particular set of protocols associated therewith. In an ANSI type network a digit length of 1-10 digits is used for the subscriber's number and is referred to as a mobile identifier number (MIN), again having a particular set of protocols associated therewith. According to both IMSI and MIN subscriber number conventions, the subscriber number may be expressed and transmitted, stored, etc., over a network in octet form. As the reader will appreciate, each octet represents a byte, or 8 bits of data represented in Hexidecimal form. Thus, each octet can represent two (2) digits of a called number (4 bits being sufficient to represent a number, e.g., phone digit, from 0-9). Thus, according to both IMSI and MIN subscriber number conventions, the subscriber number messages may be specified as a 10-octet structure, or greater. Such numbers are stored upon databases, e.g. an HLR and/or VLR (shown in FIG. 4), within a network for use in providing mobile service.

Certain portions of a digit string of numbers can be used for sorting and storing subscriber numbers in a database. For example, the first several numbers in a subscriber's number can be used for “keying” (e.g., arranging in some order) a database of subscriber numbers. Subscriber numbers can have fixed (e.g., within a numbering convention) and/or varying digit lengths (e.g., between different numbering conventions). Thus, using a first set of digits or another sorting mechanism can be useful when keying a database with subscriber numbers. According to the embodiment shown in FIG. 3A, the one or more physical databases, 305-1, 305-2, 305-3, and 305-4 within database 314, are keyed, e.g., grouped by certain digits in the subscribers number using the first two octets of the number, i.e., the first four digits.

According to embodiments of the present invention, a program developer keys a database, such as database 314, with subscriber numbers. The programmer, in developing the database, further associates with each number a protocol which the developer knows is appropriate for that particular number. For example, according to embodiments described herein, the numbers keyed to database 314 in association with certain numbers are destination or “called” numbers. The protocols associated with each called number in the database 314 represent the protocol type will be needed by a program to handle a session with that called number. Thus in the case where an application, e.g., a Parlay web based application, initiates a call to a called number, the program embodiments described herein, i.e., dispatcher program, will execute instructions to extract the called number (whether from the TCAP or elsewhere in the SS7 layers) and will execute instructions to use that called number in performing a look up in database 314 to identify the appropriate protocol to use with that called number. The program instructions can execute to launch a protocol specific program to handle the session with the called number, e.g., to instantiate a protocol specific SLP in a SLEE.

As shown in FIG. 3A, program instructions are provided in the form of a dispatcher program 304 which can execute to search the one or more physical databases, e.g., 305-1, 305-2, 305-3, and 305-4, within database 314 as populated by called number types, e.g., the key ranges described above, and their associated protocol types (shown in FIG. 3B) in order to identify an appropriate protocol type to handle a session.

As shown in FIG. 3A, the dispatcher program can include a dispatcher SLP. However, embodiments are not limited to this example embodiment in FIG. 3A. As described above, and illustrated in FIG. 3A, a dispatcher SLP can receive a called number (or session type) as contained in an SS7 message initiated from a network application 302. The call message initiated by a network application, e.g., a Parlay application, is also referred to herein as an initial service request received from the network application 302. As the reader will appreciate, an SS7 message can also contain information on a session type in addition to called number information. A called number can include a called number selected from the group of a MIN and/or an IMSI number. Embodiments, however, are not limited to these examples.

The SS7 message, however, will not contain the protocol type identification for the service application 302 initiating the service request. Thus, as described herein, program instructions are provided such that each called number can be searched in database 314, according to a key range or other sorting technique, and produce a predefined, e.g. developed identified, protocol. In the embodiment of FIG. 3A, the above described technique is illustrated by look up tables, e.g., 306-1 and 307-1, 306-2 and 307-2, 306-3 and 307-3, and 306-N and 307-N. The designator “N” is intended to illustrate that a number of such look up tables can be included. Embodiments are not limited to the example in FIG. 3A. In the example of FIG. 3A, blocks 306-1, 306-2, 306-3, and 306-N represent sorted called number tables and blocks 307-1, 307-2, 307-3, and 307-N represent tables having the appropriate protocols associated with each of those called numbers.

FIG. 3B illustrates a table embodiment with called numbers associated to particular protocol types. That is, FIG. 3B illustrates in more detail an example in which a programmer has defined in tables 306-1 and 307-1 an association between a called number and an associated protocol to use in selecting and launching an appropriate protocol specific SLP. For example, when program embodiments receive a called number of 12497, the program instructions execute to identify the CAMEL protocol as the protocol type in order to launch a SLP suited to handle messaging with this particular called number. In the example, if a called number 12499 is received, the program instructions execute to identify the CS protocol as the protocol type in relation to that called number in order to launch a SLP suited to handle messaging with this particular called number. And, in this example, if a called number 137638 is received, the program instructions execute to identify the INAP protocol as the protocol type in relation to that called number in order to launch a SLP suited to handle messaging with this particular called number.

In one operational embodiment, the program instructions, e.g., dispatcher SLP 304, execute instructions to search the called numbers within the key ranges based on called number and execute to retrieve protocol information (e.g., a protocol type), associated with each called number in look up tables, 306-1 and 307-1, 306-2 and 307-2, 306-3 and 307-3, and 306-N and 307-N, in order to initiate an appropriate SLP in the SLEE environment shown in FIG. 2. The protocol types can include protocol types selected from the group of: an intelligent network application part (INAP) protocol; a capabilities set (CS) protocol; a second generation customized applications for mobile enhanced logic (CAMEL 2) protocol; a third generation CAMEL (CAMEL 3) protocol; a mobile application part (MAP) protocol, etc.

Example Interaction between Network Functions Service Applications and a SCP having a Dispatcher SLP

FIG. 4 is an example illustration of the interaction between a number of network functions and service functions which can include program embodiments as described herein. FIG. 4 is an example illustration of the interaction between a number of network functions and service functions. In FIG. 4, a number of functions within network 400 interact with a number of services provided through an SCP 436. The network functions, e.g., home location register (HLR) 414, visitor location register (VLR) 424, gateway mobile switching center/controller (GMSC) 412, service mobile switching center/controller (SMSC) 426, billing 422, and other functions 438, can communicate requests for services including requests for data, communications between devices or networks, and the like, which will employ SLPs. These requests for services and the responses to such requests can be provided by a number of different protocols, such as INAP, MAP, CAMEL, CS protocols, etc. The requests are directed to the SCP 436 via transaction capabilities application part (TCAP) messages 440 to create a session, e.g., message exchange, with an SLP 443-1, 443-2, 443-3, . . . 443-N within a SLEE 442. The designator “N” is used to illustrate that a number of such SLPs can be created. As noted herein, the SLEE is an environment in which SLP instances are created. The SLEE 442 can serve as the SCF 441 on an SCP 436.

A given SLP may connect via a communication link 444 with one of a number of service applications 446, including a Parlay initiated call, and/or service data 448 using the program embodiments described herein to fulfill the requests for services, including launching a program having an appropriate protocol to handle a session between the service application and called number. That is, according to embodiments described herein the network functions 400 and the service applications 446 and/or service data 448 interact with the SCP 436 via a plug in having a dispatcher program 406 as the same has been described herein.

Although specific embodiments have been illustrated and described herein, those of ordinary skill in the art will appreciate that an arrangement calculated to achieve the same techniques can be substituted for the specific embodiments shown. This disclosure is intended to cover adaptations or variations of various embodiments of the invention. It is to be understood that the above description has been made in an illustrative fashion, and not a restrictive one.

Combination of the above embodiments, and other embodiments not specifically described herein will be apparent to those of skill in the art upon reviewing the above description. The scope of the various embodiments of the invention includes other applications in which the above structures and methods are used. Therefore, the scope of various embodiments of the invention should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A method for handling a session in a telecommunications network, comprising:
receiving a service request to a network device, the service request associated with a service application;
identifying a protocol type of the service application to handle the session based on a database look up; and
instantiating a program on the network device appropriate to the protocol type based on identifying the protocol type.

2. The method of claim 1, further including receiving the service request to a plug-in component associated with the network device, the plug-in component including a dispatcher program.

3. The method of claim 1, further including using the dispatcher program to identify the protocol type.

4. The method of claim 3, further including using the dispatcher program to identify the protocol type based on a portion of a called number.

5. The method of claim 3, further including using the dispatcher program to identify the protocol type based on a session type.

6. The method of claim 1, further including instantiating a protocol specific service logic program.

7. The method of claim 1, further including receiving a service request initiated by a network application.

8. The method of claim 1, further including receiving a service request initiated by a web-based Parley service application.

9. A method for handling a session in a telecommunications network, comprising:
receiving a service request to a network device, the service request initiated by a service application accessible to the network;
executing instructions associated with a dispatcher program to search a protocol database in order to identify a protocol type of the service application; and
instantiating a protocol specific service logic program (SLP) on the network device based on identifying the protocol type.

10. The method of claim 9, further including populating the protocol database with protocols associated with a called number type.

11. The method of claim 10, further including populating the protocol database with protocols associated with ANSI and GSM number types.

12. The method of claim 10, further including searching the protocol database based on a portion of the called number type to identify the protocol type.

13. The method of claim 9, further including receiving the service request to a dispatcher program on a service capability server.

14. The method of claim 13, further including instantiating a protocol specific service logic program (SLP) in a multiple service logic execution environment (multi-SLEE).

15. The method of claim 13, further including executing instructions associated with the dispatcher program to route subsequent messages to the protocol specific SLP.

16. A computer readable medium having program instructions to cause a device to perform a method, comprising:
receiving a service request to a network device, the service request initiated by a service application accessible to the network;
searching a protocol database to identify a protocol type of the service application; and
instantiating a service logic program (SLP) on the network device appropriate to the protocol type.

17. The medium of claim 16, further including receiving the service request as part of a transactions capabilities application part (TCAP) message.

18. The medium of claim 17, further including receiving the service request to a dispatcher SLP associated with a service logic execution environment.

19. The medium of claim 18, further including executing instructions associated with the dispatcher SLP to search the protocol database based on a portion of a called number.

20. The medium of claim 18, further including executing instructions associated with the dispatcher SLP to search the protocol database based on a session type.

21. The medium of claim 20, further including instantiating a protocol specific SLP to handle a session with the service application and using the dispatcher SLP to route subsequent messages to the protocol specific SLP.

22. A network device, comprising:
a processor;
a memory coupled to the processor; and
program instructions storable in the memory and executable by the processor to:
receive a service request to the network device, the service request initiated by a service application accessible to the network;
search a protocol database to identify a protocol type of the service application; and
instantiate a service logic program (SLP) on the network device appropriate to the protocol type to handle a session with the service application.

23. The device of claim 22, wherein the network device is selected from the group of:
a service capability server (SCS);
a service control gateway (SCG); and
a service control point (SCP).

24. The device of claim 22, wherein the program instructions execute to search a database populated by called number types associated with various protocol types.

25. The device of claim 24, wherein the called number types include a called number selected from the group of:
a mobile identifier number (MIN); and
an international mobile subscriber identity (IMSI) number.

26. The device of claim 24, wherein the various protocol types include protocol types selected from the group of:
an intelligent network application part (INAP) protocol;
a capabilities set (CS) protocol;
a second generation customized applications for mobile enhanced logic (CAMEL 2) protocol;
a third generation CAMEL (CAMEL 3) protocol; and
a mobile application part (MAP) protocol.

27. The device of claim 22, wherein the service application includes a web-based Parlay service application.

28. The device of claim 22, wherein the program instructions execute to search a database according to a session type, wherein the session type includes:
an ANSI message exchange; and
a GSM message exchange.

29. The device of claim 22, wherein the program instructions execute as part of a dispatcher SLP and execute to initiate a protocol specific SLP in a multiple service logic execution environment (multi-SLEE) on the network device appropriate to handle the session with the service application.

30. A network device, comprising:
a processor;
a memory coupled to the processor; and
means for instantiating a protocol specific service logic program (SLP) based on a service request from a service application.

31. The device of claim 30, wherein the means includes a dispatcher program having executable instructions to search a protocol database to identify a protocol type associated with the service application.

32. The device of claim 31, wherein the dispatcher program includes program instructions which execute to search the protocol database using a portion of a called number.

33. The device of claim 32, wherein the dispatcher program includes program instructions which execute to search the protocol database base on a called number contained in a transactions capabilities application part (TCAP) message.

34. A communications network, comprising:
a service switching point (SSP);
a service control point (SCP) connected to the SSP;
a service capability server (SCS) connected to the SCP and SSP;
a service control gateway (SCG) connected to the SCP and SSP; and
a service logic execution environment (SLEE) provided via access to processor and memory resources on the network, wherein the SLEE can instantiate one or more protocol specific service logic programs (SLPs) based on a service request from a service application.
